(19) United States
(12) Patent Application Publication
(10) Pub. No.: US 2013/0213552 A1
(43) Pub. Date: Aug. 22, 2013

(54) VIBRATORY WELDER HAVING LOW THERMAL CONDUCTIVITY TOOL

(71) Applicant: Branson Ultrasonics Corporation, (US)

(72) Inventors: Peter KELCH, Bethel, CT (US); Allan J. ROBERTS, Poughquag, NY (US); John WNEK, Westbrook, CT (US)

(73) Assignee: BRANSON ULTRASONICS CORPORATION, Danbury, CT (US)

(21) Appl. No.: 13/756,807

(22) Filed: Feb. 1, 2013

Related U.S. Application Data
(60) Provisional application No. 61/600,852, filed on Feb. 20, 2012.

(51) Int. Cl. B29C 65/08; B23K 20/10

(52) U.S. Cl. CPC B29C 65/08; B23K 20/10
USPC 156/73.1; 228/110.1; 228/1.1; 156/580.2

(57) ABSTRACT

In accordance with an aspect of the present disclosure, a vibratory welder for welding parts together has a vibratory tool made from a material having a low thermal conductivity of no greater than 5 watt/meter degree Kelvin and also having a sufficient strength and toughness for vibratory welding. In an aspect, the vibratory tool is made of a material having a compressive strength of at least 80 MPa (megapascals) tensile and a fracture toughness (K_{lc}) of at least 3 MPa(m)^{1/2}.

### CROSS-REFERENCE TO RELATED APPLICATIONS

This application claims the benefit of U.S. Provisional Application No. 61/600,852, filed on Feb. 20, 2012. The entire disclosure of the above application is incorporated herein by reference.

### FIELD

The present disclosure relates to vibratory welding.

### BACKGROUND

This section provides background information related to the present disclosure which is not necessarily prior art.

Vibratory welding as commonly understood involves welding two metal or two plastic pieces together by vibration. Two common types of vibratory welding are ultrasonic welding and friction welding. Friction welding is also known as vibration welding.

A model of a typical ultrasonic metal welding apparatus 100 is shown in FIG. 1. Typical components of ultrasonic metal welding apparatus 100 include an ultrasonic transducer 102, a booster 104, and an ultrasonic horn 106. Electrical energy from a power supply 101 at a frequency of 20-60 kHz is converted to mechanical energy by the ultrasonic transducer 102. The mechanical energy converted in the ultrasonic transducer 102 is transmitted to a weld load 108 (such as two pieces of metal 112, 114) through the booster 104 and the horn 106. The booster 104 and the horn 106 perform the functions of transmitting the mechanical energy as well as transforming mechanical vibrations from the ultrasonic transducer 102 by a gain factor.

The mechanical vibration that results on a horn tip 110 is the motion that performs the task of welding metal together. Horn tip 110 may be made of tungsten carbide or other high strength, hard material. The metal pieces 112, 114 to be welded together are placed adjacent to the horn tip 110. The horn tip 110 is brought into contact with top metal piece 112 to be welded. In the embodiment of FIG. 1, horn 106 includes two horn tips 110, one of which is brought into contact with top metal piece 112. The axial vibrations of the ultrasonic horn 106 now become shear vibrations to the top metal piece 112. The shear vibrations are transmitted to the top metal piece 112, causing it to move back and forth with respect to bottom metal piece 114 causing surfaces of the two metal pieces abutting each other at a weld interface to be heated, eventually melting together. A weld anvil 120 grounds the bottom metal piece 114. It should be understood that such an ultrasonic welder can be used to weld multiple metal foil layers together, such as several layers of aluminum or copper foil.

A similar apparatus is used in ultrasonically welding plastic pieces together. The principal difference is that the ultrasonic horn oscillates in a manner to impart vertical oscillations in the plastic pieces. That is, the ultrasonic horn causes oscillatory compression/decompression of the plastic pieces with respect to each other causing surfaces of the plastic pieces abutting each other at a weld interface to be heated, eventually melting together.

Ultrasonic welders are for example disclosed in U.S. Pat. No. 5,658,408 for Method for Processing Workpieces by Ultrasonic Energy; “U.S. Pat. No. 6,863,205 for Anti-Splice Welder,” and US Pat. Pub. No. 2008/0054051 for “Ultrasonic Welding Using Amplitude Profiling.” The entire disclosures of the foregoing are incorporated herein by reference.

In one type of friction welder, two pieces, such as thermoplastic pieces, are urged together and reciprocated with respect to each other during a weld interval. The resulting friction where surfaces of the two pieces abut each other at a weld interface to be heated, eventually melting together. FIG. 2 shows a basic model of such a friction welder. Friction welder 200 includes a vibratory head 202 having a tool 204. Cylinders 206, which may be hydraulic, electric or pneumatic, are mounted on a base plate 208 and attached to a table 210. The two pieces to be friction welded are positioned on an anvil 212, which may be recessed in a top of table 210. Cylinders 206 move table 210 against vibratory head 202, pushing the plastic pieces against vibratory head 202. Vibratory head is then energized to vibrate and vibrates the two plastic pieces so that they reciprocate with respect to each other. It should be understood that friction welder 200 could alternatively be configured so that table 210 remains stationary and vibratory head 202 lowered to bring tool 204 into contact with the plastic pieces. Illustratively, vibratory head 202 may for example vibrate in the range of 60 Hz-320 Hz.

Friction welders are also sometimes referred to as vibration welders. Friction welders are for example described in U.S. Pat. No. 3,920,504 to Show et al. for “Friction Welding Apparatus,” and U.S. Pat. No. 4,352,711 to Toth for “Friction Welding Apparatus,” the entire disclosures of which are incorporated herein by reference.

### SUMMARY

This section provides a general summary of the disclosure, and is not a comprehensive disclosure of its full scope or all of its features.

In accordance with an aspect of the present disclosure, a vibratory welder for welding parts together has a vibratory tool made from a material having a low thermal conductivity of no greater than 5 watt/meter degree Kelvin and also having a sufficient strength and toughness for vibratory welding. In an aspect, the vibratory tool is made of a material having a compressive strength of at least 80 MPa (megapascals) tensile and fracture toughness (K_{lc}) of at least 3 MPa(m)^{1/2}.

In an aspect, the parts being welded are disposed in the vibratory welder between the vibratory tool and an anvil of the vibratory welder. The anvil is also made of the material having the above low thermal conductivity, compressive strength and toughness properties.

In accordance with an aspect of the present disclosure, the vibratory welder is an ultrasonic welder and the vibratory tool is an ultrasonic horn.

In accordance with an aspect of the present disclosure, the vibratory welder is a friction welder having a vibratory head which has the vibratory tool.

In accordance with an aspect of the present disclosure, a method of welding parts in a vibratory welder includes using as a vibratory tool of the vibratory welder a vibratory tool made of a material having a low thermal conductivity of no greater than 5 watt/meter degree Kelvin and also having a sufficient strength and toughness for vibratory welding. The method includes placing the parts in the vibratory welder, vibrating the vibratory tool, and contacting at least one of the parts with the vibrating vibratory tool. In an aspect, the method includes using as an anvil of the vibratory welder an anvil made of the material having the above low thermal conductivity, strength and toughness properties. In this aspect, the parts are placed on the anvil so that the anvil contacts at least one of the parts that is different than the part contacted by the vibratory tool.

In accordance with an aspect of the present disclosure, a method of welding parts in an ultrasonic welder includes using an ultrasonic horn of the ultrasonic welder an ultrasonic horn made of a material having a low thermal conductivity of no greater than 5 watt/meter degree Kelvin and also having a sufficient strength and toughness for ultrasonic welding. The method includes placing the parts in the ultrasonic welder, ultrasonically vibrating the ultrasonic horn, and contacting at least one of the parts with the ultrasonic horn. In an aspect, the method includes using as an anvil of the ultrasonic welder an anvil made of the material having the above low thermal conductivity, strength and toughness properties.

In an aspect, the parts to be welded in the ultrasonic welder are plastic parts each having a plastic film layer having a thickness of no more than 0.002 inches and the method includes reducing overmelt at a weld interface of the parts being welded by the use of an ultrasonic horn made of a material having low thermal conductivity a low thermal conductivity of no greater than 5 watt/meter degree Kelvin and also having a sufficient strength and toughness for ultrasonic welding. In an aspect, the plastic film layer is a plastic coated foil.

In an aspect, the method includes welding as the parts to be welded in the ultrasonic welder at least sixty layers of aluminum or copper foil with each layer having a thickness no greater than 0.002 inches and the method includes using as the ultrasonic horn an ultrasonic horn made of a material having low thermal conductivity a low thermal conductivity of no greater than 5 watt/meter degree Kelvin and also having a sufficient strength and toughness for ultrasonic welding and having a face that contacts one of the layers of foil during welding where the face has a knurl pattern having an aspect ratio defined by height of the ridges of the knurl pattern divided by width of the ridges (at the base of the ridges) that is less than 0.50. In an aspect, the method includes welding as the parts to be welded in the ultrasonic welder at least ninety layers of aluminum or copper foil with each layer having a thickness no greater than 0.002 inches.

In accordance with an aspect of the present disclosure, a method of friction welding parts together in a fraction welder includes using a vibratory tool of the friction welder a vibratory tool made of a material having a low thermal conductivity of no greater than 5 watt/meter degree Kelvin and also and also having a sufficient strength and toughness for friction welding. The method includes placing the parts in the friction welder, vibrating the vibratory tool, and contacting at least one of the parts with the vibrating vibratory tool. In an aspect, the method includes using as an anvil of the friction welder an anvil having a contact surface made of the material having the above low thermal conductivity, compressive strength and toughness properties.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is schematic view of a prior art ultrasonic welder;

FIG. 2 is a schematic view of a prior art friction welder;

FIG. 3 is a schematic view of an ultrasonic welder having a horn tip of an ultrasonic horn and an anvil in accordance with an aspect of the present disclosure;

FIG. 4 is a schematic view of a friction welder having a tool of a vibratory head and an anvil in accordance with an aspect of the present disclosure;

FIG. 5 is a perspective view of the ultrasonic horn of FIG. 3; and

FIG. 6 is a perspective view of the anvil of FIG. 3.

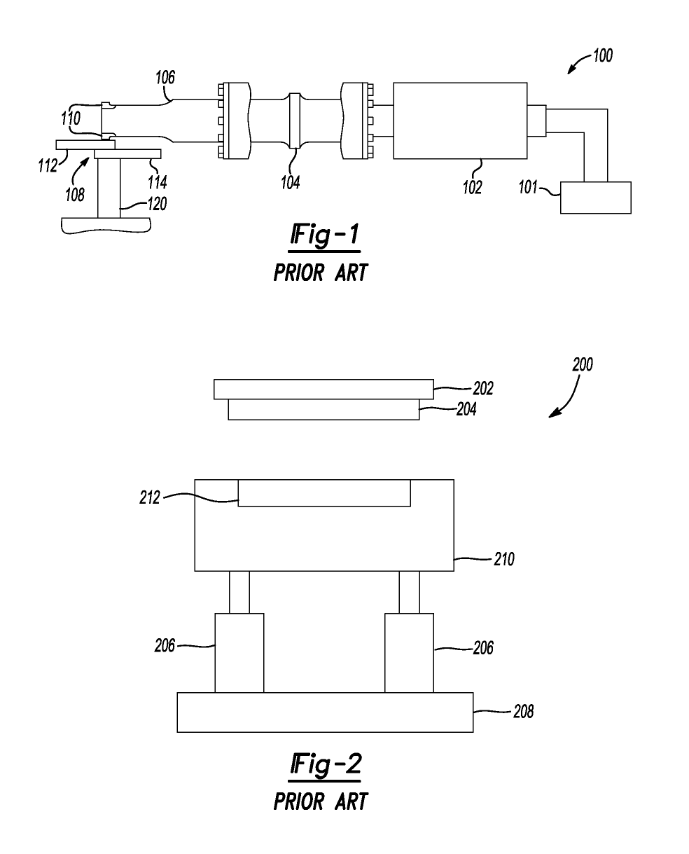

Corresponding reference numerals indicate corresponding parts throughout the several views of the drawings.

### DETAILED DESCRIPTION

Example embodiments will now be described more fully with reference to the accompanying drawings.

In accordance with an aspect of the present disclosure, a vibratory welder has a vibratory tool made from a material having a low thermal conductivity no greater than 5 watt/meter degree Kelvin and also having a sufficient strength and toughness for vibratory welding. In an aspect, the vibratory tool is made of a material having a compressive strength of at least 80 MPa tensile and fracture toughness (K_{lc}) of at least 3 MPa(m)^{1/2}. In an aspect, an anvil of the vibratory welder on which the parts to be welded are placed is also made of the material having the above low thermal conductivity, strength and toughness properties. It should be understood that that when it is referred to herein as the vibratory tool being made of the material having the above low thermal conductivity, strength and toughness properties, this means that the vibratory tool can be made of this material, or that a face of the vibratory tool that contacts at least one of the parts being welded is made of this material with the remainder of vibratory tool being made of a different material. Similarly, when it is referred to herein as the anvil being made of the material having the above low thermal conductivity, strength and toughness properties, this means that the entire anvil can be made of this material, or that a face of the anvil that contacts a part being welded is made of this material.

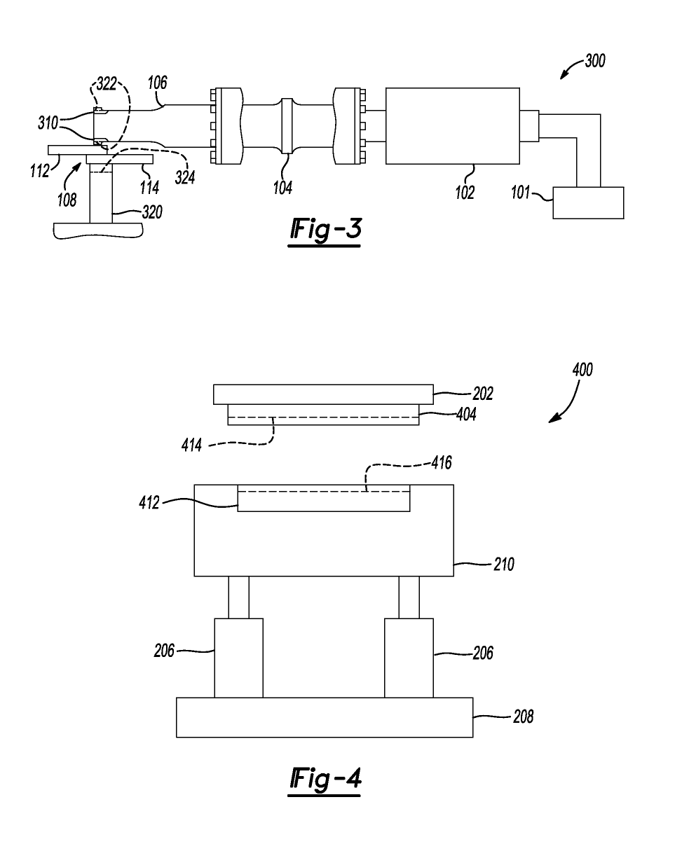

The vibratory welder may be an ultrasonic welder such as ultrasonic welder 300 (FIG. 3), the vibratory tool may be an ultrasonic horn 106 but having one or more horn tips such as horn tip 310 (FIG. 3) and the anvil may be an anvil such as anvil 320 (FIG. 3). The vibratory welder may be a friction welder such as friction welder 400 (FIG. 4), the vibratory tool may be tool 404 (FIG. 4) of vibratory head 202, and the anvil may be anvil 412 (FIG. 4).

FIG. 3 shows an ultrasonic welder 300 having an ultrasonic horn tip 310 and anvil 320 in accordance with the present disclosure. With the following differences, ultrasonic welder 300 has the same basic elements as ultrasonic welding apparatus 100. Like elements will be identified with the same reference numbers and the discussion of ultrasonic welder 300 will focus on the differences. It should be understood that horn tip 310 may be considered a type of vibratory tool.

In an aspect, of the present disclosure, horn tip 310 is made from a material having a low thermal conductivity of no greater than 5 watt/meter degree Kelvin and also having a sufficient strength and toughness for ultrasonic welding. In an aspect, the horn tip 310 is made of a material having a compressive strength of at least 80 MPa tensile and fracture toughness (K_{lc}) of at least 3 MPa(m)^{1/2}. In an aspect of the present disclosure, anvil 320 may also be made of the material having the above low thermal conductivity, strength and toughness properties. It should be understood that that when it is referred to herein as horn tip 310 being made of the material having the above low thermal conductivity, strength and toughness properties, this means that the entire horn tip 310 can be made of this material, or that a face of the horn tip 310 that contacts top metal piece 112 (face 322 shown in phantom in FIG. 3) is made of this material, with the remainder of horn tip 310 being made of a different material, such as material having higher thermal conductivity. Similarly, when it is referred to herein as anvil 320 being made of the material having the above low thermal conductivity, strength and toughness properties, this means that the entire anvil 320 can be made of this material, or that a face of the anvil 320 that contacts at least one of the parts being welded, such as bottom metal piece 114 (face 324 shown in FIG. 6 and in phantom in FIG. 3) is made of this material, with the remainder of anvil 320 being made of a different material, such as a material having a higher thermal conductivity.

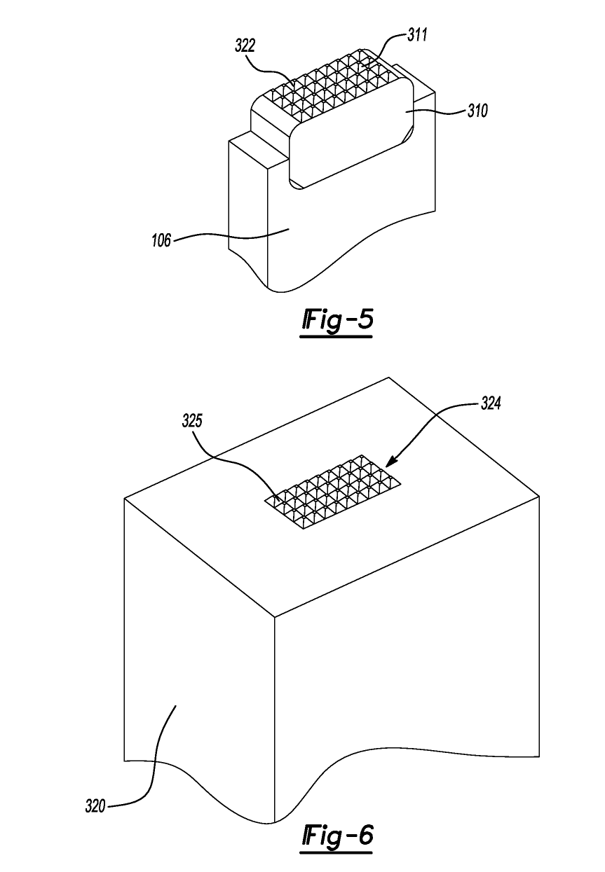

In an aspect, the parts to be welded in the ultrasonic welder are layers of aluminum or copper foil having a thickness no greater than 0.002 inches and the face 322 of horn tip 310 has a knurl pattern 311 (FIG. 5) having an aspect ratio defined by height of the ridges of the knurl pattern divided by width of the ridges (at the base of the ridges) of less than 0.5. In an aspect, the face 324 of anvil 320 also has knurl pattern 325 having an aspect ratio of less than 0.5.

In an aspect, the parts to be welded include at least sixty layers of aluminum or copper foil having a thickness no greater than about 0.002 inches. In an aspect, the parts to be welded include at least ninety layers of aluminum or copper foil having a thickness no greater than 0.002 inches.

Heretofore, when ultrasonic welding has been used to weld a stack of aluminum or copper foil layers of more than about forty to fifty layers of foil, such as for use in batteries, the face of the horn tip that contacts a top layer of the layers of foil has had to have a more aggressive knurl with an aspect ratio greater than 0.5, in order to achieve the requisite peel strength at the weld between the bottom layer and the next adjacent layer of the layers of foil. Top and bottom are used for convenience of reference, with the top layer and bottom layers being the outermost layers of the layers of the stack of foil layers at opposed ends of the stack of foil layers.

Using a horn tip made of material the material having the above low thermal conductivity provides better control of the weld energy through the stack of aluminum or copper foil layers (i.e., less dispersion due to thermal conduction through the horn tip), so that more layers can be welded with a horn tip having a face with a less aggressive knurl heretofore has been needed, and with lower energy consumption. For example, applicants have welded a stack of aluminum foil layers having ninety-six aluminum foil layers each with a thickness of 0.002 using a horn tip having a face without the more aggressive knurl pattern heretofore needed for this number of aluminum foil layers, and with a reduction of energy consumption in the range of thirty to forty percent. Also using an anvil made of the material having the above low thermal conductivity, strength and toughness properties enhances the above described benefit.

The use of ceramic oxides as the material also reduces sticking of the horn tip to the top aluminum or copper foil layer.

FIG. 4 shows a friction welder 400 having an anvil 412 and a tool 404 of vibratory head in accordance with the present disclosure. With the following differences, friction welder 400 has the same basic elements as friction welder 200. Like elements will be identified with the same reference numbers and the discussion of friction welder 400 will focus on the differences. It should be understood that tool 404 may be considered a type of vibratory tool.

In an aspect, of the present disclosure, tool 404 of vibratory head 202 is made from a material having a low thermal conductivity of no greater than 5 watt/meter degree Kelvin and also having a sufficient strength and toughness for friction welding. In an aspect, tool 404 is made of a material having a compressive strength of at least 80 MPa tensile and fracture toughness (K_{lc}) of at least 3 MPa(m)^{1/2}. In an aspect of the present disclosure, anvil 412 may also be made of this material. It should be understood that that when it is referred to herein as tool 404 being made of the material having the above low thermal conductivity, compressive strength and toughness properties, this means that the entire tool 404 can be made of this material having low thermal conductivity, or that a face of the tool 404 that contacts at least one of the parts being welded (face 414 shown in phantom in FIG. 4) is made of the material having the above low thermal conductivity, compressive strength and toughness properties, with the remainder of tool 404 being made of a different material, such as a material having a higher thermal conductivity. Similarly, when it is referred to herein as anvil 412 being made of the material having the above low thermal conductivity, compressive strength and toughness properties, this means that the entire anvil 412 can be made of this material having low thermal conductivity, or that a face of the anvil 412 that contacts at least one of the parts being welded (face 416 shown in phantom in FIG. 4) is made of the material having the above low thermal conductivity, compressive strength and toughness properties, with the remainder of anvil 412 being made of a different material, such as a material having a higher thermal conductivity.

In an aspect of the present disclosure, the material having the above properties of a low thermal conductivity of no greater than 5 watt/meter degree Kelvin, compressive strength of at least 80 megapascals (MPa) Tensile and fracture toughness (K_{lc}) of at 3 MPa(m)^{1/2} is a ceramic oxide comprising at least fifty percent zirconia. In an aspect, the ceramic oxide comprises approximately eighty-five percent zirconia and fifteen percent alumina. In an aspect of the present disclosure, the material having the above properties of a low thermal conductivity, strength and toughness can be any of the materials in the oxide family of ceramics having (or alloyed or otherwise modified to have) the above properties, including but not limited to, mullite, cordierite, steatite, or porcelain.

In accordance with an aspect of the present disclosure, a method of reducing overmelt at a weld interface at a junction of abutting parts in welding of the parts in a vibratory welder includes using as a vibratory tool of the vibratory welder a vibratory tool made of a material having a low thermal conductivity of no greater than 5 watt/meter degree Kelvin and also having sufficient strength and toughness for vibratory welding. In an aspect, the vibratory tool is made of a material having a compressive strength of at least 80 MPa tensile and a fracture toughness (K_{lc}) of at least 3 MPa(m)^{1/2}. The method includes placing the parts in the vibratory welder, vibrating the vibratory tool, and contacting at least one of the parts with the contact surface of the vibrating vibratory tool. In an aspect, the method includes using as an anvil of the vibratory welder an anvil made of the material having the above low thermal conductivity, compressive strength and toughness properties. In an aspect, the method includes reducing overmelt at a weld interface of a plastic film layer to another plastic part to another part in welding the parts in a vibratory welder. In an aspect, the plastic film layer has a thickness no greater than 0.002 inches. In an aspect, the plastic film layer is plastic coated foil.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of welding parts in a vibratory welder, comprising:
placing parts in a vibratory welder having a vibratory tool made of a material having a low thermal conductivity of no greater than 5 watt/meter degree Kelvin and also having a compressive strength of at least 80 MPa tensile and a fracture toughness of at least 3 MPa(m)^{1/2};
vibrating the vibratory tool; and
contacting at least one of the parts with the vibrating vibratory tool.

2. The method of claim 1 wherein placing parts in the vibratory welder includes placing them in a vibratory welder having an anvil made of a material having a low thermal conductivity of no greater than 5 watt/meter degree Kelvin and also having a compressive strength of at least 80 MPa tensile and a fracture toughness of at least 3 MPa(m)^{1/2}, wherein placing the parts in the vibratory welder includes placing the parts on the anvil so that the anvil contacts at least one of the parts that is different than the part contacted by the vibratory tool.

3. The method of claim 1 wherein placing the parts in the vibratory welder includes placing them in a friction welder having a vibratory head which has the vibratory tool and vibrating the vibratory tool includes vibrating the vibratory head so that it vibrates at a frequency in a range of 60 Hz-320 Hz.

4. The method of claim 1 wherein placing the parts in the vibratory welder includes placing them in an ultrasonic welder having an ultrasonic horn that is the vibratory tool and vibrating the vibratory tool includes vibrating the ultrasonic horn so that it vibrates at an ultrasonic frequency in the range of 20 Khz to 60 Khz.

5. The method of claim 4 wherein placing the parts in the ultrasonic welder includes placing parts that are plastic parts in the ultrasonic welder where each of the plastic parts have a plastic film layer having a thickness of no more than 0.002 inches.

6. The method of claim 4 wherein placing the parts in the ultrasonic welder includes placing at least sixty parts that are stacked together in the ultrasonic welder that are each a layer of aluminum or copper foil having a thickness no greater than 0.002 inches and wherein contacting at least one of the parts with the ultrasonic horn includes contacting it with a face of the ultrasonic horn that has a knurl pattern having an aspect ratio that is less than 0.50.

7. The method of claim 6 wherein placing the parts in the ultrasonic welder includes placing at least ninety parts that are stacked together in the ultrasonic welder that are each a layer of aluminum or copper foil having a thickness no greater than 0.002 inches.

8. The method of claim 4 wherein using as the vibratory tool the vibratory tool made from the material having the compressive strength of at least 80 MPa tensile and the fracture toughness of at least 3 MPA(m))^{1/2} includes using as the vibratory tool a vibratory tool made from a ceramic oxide comprising at least fifty percent zirconia.

9. The method of claim 8 wherein using as the vibratory tool the vibratory tool made from the ceramic oxide using as the vibratory a vibratory tool made from ceramic oxide comprising approximately eight-five percent zirconia and fifteen percent alumina.

10. The method of claim 1 wherein using as the vibratory tool the vibratory tool made from the material having the compressive strength of at least 80 MPa tensile and the fracture toughness of at least 3 MPA(m))^{1/2} includes using as the vibratory tool a vibratory tool made from a ceramic oxide comprising at least fifty percent zirconia.

11. The method of claim 10 wherein using as the vibratory tool the vibratory tool made from the ceramic oxide includes using as the vibratory a vibratory tool made from ceramic oxide comprising approximately eight-five percent zirconia and fifteen percent alumina.

12. A method of ultrasonically welding a stack of layers of aluminum or copper foil in an ultrasonic welder having an ultrasonic horn, comprising:
using as a material for an ultrasonic horn a material having a low thermal conductivity of no greater than 5 watt/meter degree Kelvin and also having a compressive strength of at least 80 MPa tensile and a fracture toughness of at least 3 MPa(m)^{1/2};
placing the stack of layers of aluminum or copper foil in the ultrasonic welder with each layer having a thickness no greater than 0.002 inches;
vibrating the ultrasonic horn at an ultrasonic frequency in the range of 20 KHz to 60 KHz and contacting a layer of foil at an end of the stack of layers with the vibrating ultrasonic horn.

13. The method of claim 12 wherein placing the stack of layers of foil in the ultrasonic welder includes placing a stack having at least sixty layers of the foil in the ultrasonic welder.

14. The method of claim 13 wherein placing the stack of layers of foil in the ultrasonic welder includes placing a stack having at least ninety layers of the foil in the ultrasonic welder.

15. The method of claim 13 wherein contacting the layer of foil with the vibrating ultrasonic horn includes contacting it a face of the ultrasonic horn that has a knurl pattern having an aspect ratio of less than 0.50.

16. The method of claim 15 wherein using as the material for the ultrasonic horn includes using ceramic oxide comprising at least fifty percent zirconia.

17. The method of claim 16 wherein using as the material for the ultrasonic horn includes using ceramic oxide comprising approximately eight-five percent zirconia and fifteen percent alumina.

18. The method of claim 13 including using as a material for an anvil of the ultrasonic welder a material having a low thermal conductivity of no greater than 5 watt/meter degree Kelvin and also having a compressive strength of at least 80 MPa tensile and a fracture toughness of at least 3 MPa(m)^{1/2}.

19. The method of claim 18 wherein placing the stack of layers of foil in the ultrasonic welder includes placing them in the ultrasonic welder so that a face of the anvil having a knurl pattern having an aspect ratio that is less than 0.50 contacts a layer of the stack of layers at an end of the stack opposite the layer contacted by the face of the ultrasonic horn.

20. The method of claim 19 wherein using as the material for the anvil includes using ceramic oxide comprising at least fifty percent zirconia.

21. The method of claim 20 wherein using as the material for the anvil includes using ceramic oxide comprising approximately eight-five percent zirconia and fifteen percent alumina.

22. An ultrasonic horn for an ultrasonic welder, comprising:
a body having at least one horn tip;
the horn tip made of a material having a low thermal conductivity of no greater than 5 watt/meter degree Kelvin and also having a compressive strength of at least 80 MPa tensile and a fracture toughness of at least 3 MPa(m)^{1/2}, the horn tip having a knurl pattern having an aspect ratio that is less than 0.05.

23. The ultrasonic horn of claim 22 wherein the horn tip and body of the horn are made of the same material.

24. The ultrasonic horn of claim 22 having a plurality of horn tips.

25. The ultrasonic horn of claim 22 wherein the material of which the horn tip is made is a ceramic oxide comprising at least fifty percent zirconia.

26. The ultrasonic horn of claim 22 wherein the ceramic oxide comprises approximately eighty-five percent zirconia and fifteen percent alumina.
